(19) United States
(12) Patent Application Publication
(10) Pub. No.: US 2014/0320550 A1
(43) Pub. Date: Oct. 30, 2014

(54) LIGHT-EMITTING COMPONENT DRIVING CIRCUIT AND RELATED PIXEL CIRCUIT AND APPLICATIONS USING THE SAME

(71) Applicants: Wen-Tui Liao, Taichung City (TW); Tsung-Yu Wang, Taichung City (TW); Hsi-Rong Han, Taichung City (TW); Chih-Hung Huang, Taichung City (TW); Wen-Chun Wang, Taichung City (TW)

(72) Inventors: Wen-Tui Liao, Taichung City (TW); Tsung-Yu Wang, Taichung City (TW); Hsi-Rong Han, Taichung City (TW); Chih-Hung Huang, Taichung City (TW); Wen-Chun Wang, Taichung City (TW)

(73) Assignee: WINTEK CORPORATION, Taichung City (TW)

(21) Appl. No.: 14/259,171

(22) Filed: Apr. 23, 2014

(30) Foreign Application Priority Data
Apr. 24, 2013 (TW) 102114649

(51) Int. Cl. G09G 3/32

(52) U.S. Cl. CPC G09G 3/3233
USPC 345/690; 345/82

(57) ABSTRACT

A pixel circuit relating to an organic light emitting diode (OLED) is provided by the invention, and if the circuit configuration (5T1C or 6T1C) thereof collaborates with suitable operation waveforms, the current flowing through an OLED in the OLED pixel circuit is not be changed along with variation of a power supply voltage (Vdd) influenced by the IR drop, and is not be varied along with the threshold voltage (Vth) shift of a TFT used for driving the OLED. Accordingly, the brightness uniformity of the applied OLED display can be substantially improved.

### CROSS-REFERENCE TO RELATED APPLICATION

This application claims the priority benefit of Taiwan application serial no. 102114649, filed on Apr. 24, 2013. The entirety of the above-mentioned patent application is hereby incorporated by reference herein and made a part of this specification.

### BACKGROUND

1. Technical Field

The invention relates to a flat panel display technique. Particularly, the invention relates to a driving circuit having a light-emitting component with a self-luminous characteristic (for example, an organic light-emitting diode (OLED), though the invention is not limited thereto) and a related pixel circuit and applications thereof

2. Related Art

Along with quick development of multimedia society, semiconductor components and display devices are quickly developed. Regarding a display, since an active matrix organic light-emitting diode (AMOLED) display has advantages of no viewing angle limitation, low manufacturing cost, high response speed (more than a hundred times greater than that of liquid crystal), power saving, self-luminous, direct current (DC) driving suitable for portable products, large working temperature range, lightweight, miniaturization and thinning along with hardware equipment, etc. to cope with characteristic demands of displays of multimedia era, the AMOLED displays have a great development potential, and are expected to become innovative flat panel displays of a next generation to replace liquid crystal displays (LCDs).

There are two methods for manufacturing the AMOLED display panel, one is to use a low-temperature polysilicon (LTPS) thin film transistor (TFT) process technique, and another one is to use an a-Si TFT process technique. Since the LTPS TFT process technique requires more mask processes, the manufacturing cost thereof is increased. Therefore, the current LTPS TFT process technique is mainly applied for manufacturing middle and small size panels, and the a-Si TFT process technique is mainly applied for manufacturing large size panels.

Generally, in the AMOLED display panel manufactured by using the LTPS TFT process technique, a TFT in a pixel circuit thereof can be a P-type or an N-type TFT, though since the P-type TFT conducts positive voltage and has better driving capability, the P-type TFTs are generally used for implementation. However, in case that the P-type TFTs are used to implement the OLED pixel circuit, a current flowing through the OLED not only changes along with variation of a power supply voltage (Vdd) influenced by a current-resistance (IR) drop, but also changes along with a threshold voltage (Vth) shift of the TFT used for driving the OLED. Therefore, brightness uniformity of the OLED display is influenced.

### SUMMARY

Accordingly, in order to improve brightness uniformity of an organic light-emitting diode (OLED) display, an exemplary embodiment of the invention provides a light-emitting component driving circuit including a driving unit, a light-emitting control unit and a data storage unit. The driving unit is coupled between a power supply voltage and a light-emitting component, and includes a driving transistor. The driving unit is configured to control a driving current flowing through the light-emitting component in a light enable phase. The light-emitting control unit is coupled between the driving unit and the light-emitting component, and is configured to conduct the driving current come from the driving unit to the light-emitting component in response to a light enable signal in the light enable phase.

The data storage unit is coupled to the driving unit and includes a storage capacitor. The data storage unit stores a data voltage and a threshold voltage related to the driving transistor through the storage capacitor in response to a writing scan signal in a data-writing phase, and controls terminal voltages of the storage capacitor in response to the light enable signal in the light enable phase. In the light enable phase, the driving unit generates the driving current flowing through the light-emitting component in response to a cross-voltage of the storage capacitor, and the driving current flowing through the light-emitting component is not influenced by the threshold voltage of the driving transistor and the power supply voltage.

In an exemplary embodiment of the invention, a gate of the driving transistor is coupled to a first terminal of the storage capacitor, and a source of the driving transistor is coupled to the power supply voltage. In this case, the light-emitting control unit includes a light-emitting control transistor, where a gate thereof is configured to receive the light enable signal, and a source thereof is coupled to a drain of the driving transistor. Moreover, a first terminal of the light-emitting component is coupled to a drain of the light-emitting control transistor, and a second terminal of the light-emitting component is coupled to a reference voltage. Moreover, the light-emitting component is, for example, an organic light-emitting diode, so that the first terminal of the light-emitting component is an anode of the organic light-emitting diode, and the second terminal of the light-emitting component is a cathode of the organic light-emitting diode.

In an exemplary embodiment of the invention, the data storage unit includes a writing transistor, a collection transistor and a voltage-control transistor, where a gate of the writing transistor is configured to receive the writing scan signal, a source of the writing transistor is configured to receive the data voltage, and a drain of the writing transistor is coupled to a second terminal of the storage capacitor. A gate of the collection transistor is configured to receive the writing scan signal, a source of the collection transistor is coupled to the gate of the driving transistor and the first terminal of the storage capacitor, and a drain of the collection transistor is coupled to the drain of the driving transistor. A gate and a source of the voltage-control transistor are coupled to each other to receive the light enable signal, and a drain of the voltage-control transistor is coupled to the second terminal of the storage capacitor and the drain of the writing transistor.

In an exemplary embodiment of the invention, the driving transistor, the light-emitting control transistor, the writing transistor, the collection transistor and the voltage-control transistor are all P-type transistors. In this case, the light-emitting component driving circuit is an organic light-emitting diode driving circuit, and the organic light-emitting diode driving circuit enters the data-writing phase and the light enable phase in succession. In the data-writing phase, the writing scan signal is enabled, and the light enable signal is disabled. Moreover, in the light enable phase, the light enable signal is enabled, and the writing scan signal is disabled.

In an exemplary embodiment of the invention, the data storage unit initializes a first terminal voltage of the storage capacitor in response to a reset scan signal in a reset phase. In this case, the data storage unit further includes a reset transistor, where a gate and a source thereof are coupled to each other to receive the reset scan signal, and a drain thereof is coupled to the first terminal of the storage capacitor. The reset transistor is, for example, a P-type transistor.

In an exemplary embodiment of the invention, in case that the data storage unit has the reset transistor, the organic light-emitting diode driving circuit enters the reset phase, the data-writing phase and the light enable phase in succession. In the reset phase, the reset scan signal is enabled, and the writing scan signal and the light enable signal are disabled. In the data-writing phase, the writing scan signal is enabled, and the reset scan signal and the light enable signal are disabled. In the light enable phase, the light enable signal is enabled, and the reset scan signal and the writing scan signal are disabled.

Another exemplary embodiment of the invention provides a pixel circuit having the aforementioned light-emitting component driving circuit, and the pixel circuit is, for example, an organic light-emitting diode pixel circuit.

Another exemplary embodiment of the invention provides an organic light-emitting diode display panel having the aforementioned organic light-emitting diode pixel circuit.

Another exemplary embodiment of the invention provides an organic light-emitting diode display having the aforementioned organic light-emitting diode display panel.

According to the above descriptions, the invention provides a pixel circuit relating to an organic light-emitting diode (OLED), and if a circuit configuration (5T1C or 6T1C) thereof collaborates with suitable operation waveforms, the current flowing through the OLED is not changed along with variation of the power supply voltage (Vdd) influenced by the IR drop, and is not changed along with a threshold voltage (Vth) shift of a thin-film transistor (TFT) used for driving the organic light-emitting diode. In this way, brightness uniformity of the OLED display is greatly improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an organic light-emitting diode (OLED) pixel circuit 10 according to an exemplary embodiment of the invention.

FIG. 2 is a circuit diagram of the OLED pixel circuit 10 of FIG. 1.

FIG. 3 is an operation waveform diagram of the OLED pixel circuit 10 of FIG. 1.

FIG. 4 is another circuit diagram of the OLED pixel circuit 10 of FIG. 1.

FIG. 5 is an operation waveform diagram of the OLED pixel circuit 10 of FIG. 4.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

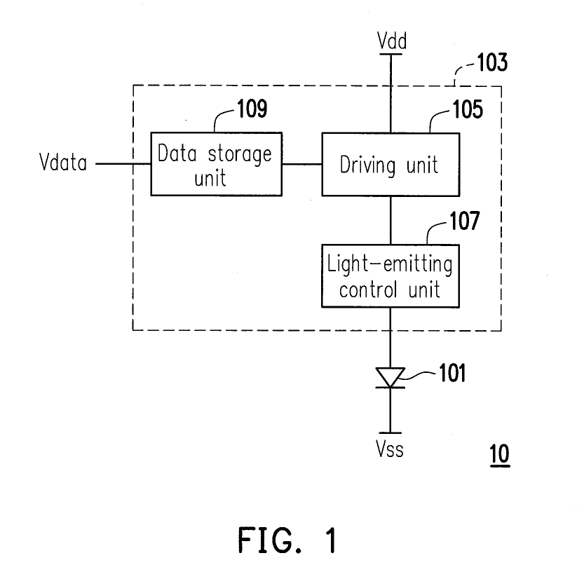

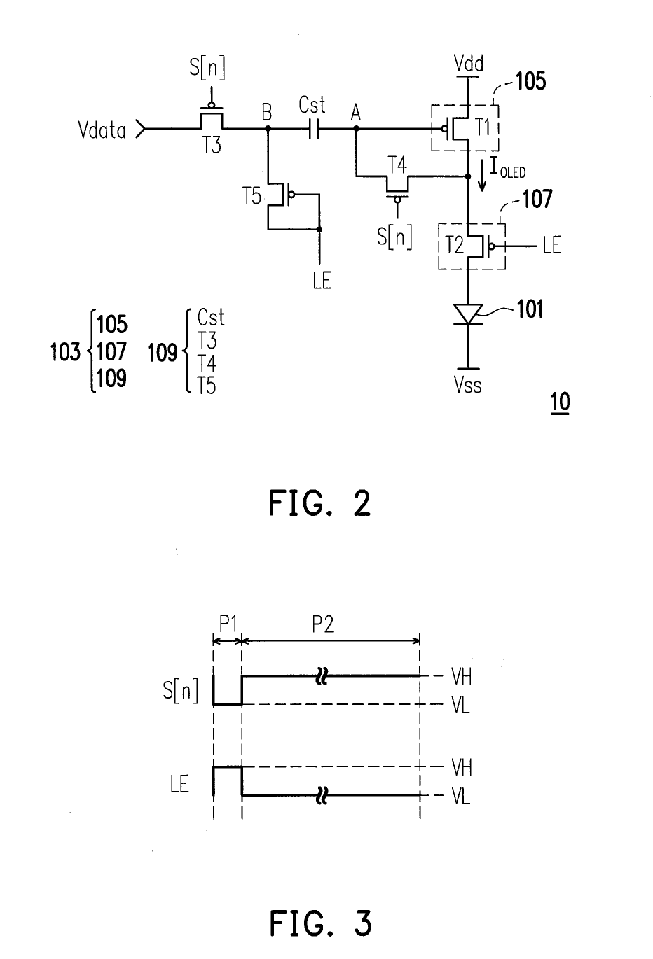

FIG. 1 is a schematic diagram of a pixel circuit 10 according to an exemplary embodiment of the invention. FIG. 2 is a circuit diagram of the pixel circuit 10 of FIG. 1. Referring to FIG. 1 and FIG. 2, the pixel circuit 10 of the present exemplary embodiment includes a light-emitting component (for example, an organic light-emitting diode (OLED) 101, though the invention is not limited thereto, so that the pixel circuit 10 can be regarded as an OLED pixel circuit) and a light-emitting component driving circuit 103. The light-emitting component driving circuit 103 includes a driving unit 105, a light-emitting control unit 107 and a data storage unit 109.

In the present exemplary embodiment, the driving unit 105 is coupled between a power supply voltage Vdd and the OLED 101 (i.e. the light-emitting component), and includes a driving transistor T1. Moreover, the driving unit 105 is configured to control a driving current I_{OLED} flowing through the OLED 101 in a light enable phase.

Moreover, the light-emitting control unit 107 is coupled between the driving unit 105 and the OLED (the light-emitting component) 101. In addition, the light-emitting control unit 107 is configured to conduct the driving current I_{OLED} come from the driving unit 105 to the OLED 101 in response to a light enable signal LE in the light enable phase.

Moreover, the data storage unit 109 is coupled to the driving unit 105, and includes a storage capacitor Cst. In addition, the data storage unit 109 stores a data voltage Vdata and a threshold voltage Vₜₕ(T1) related to the driving transistor T1 through the storage capacitor Cst in response to a writing scan signal S[n] (note: the writing scan signal S[n] can be a signal on a current scan line, which is provided by a gate driving circuit of an n^{th} stage, though the invention is not limited thereto) in a data-writing phase. Moreover, the data storage unit 109 further controls terminal voltages of the storage capacitor Cst in response to the light enable signal LE in the light enable phase.

In the present exemplary embodiment, the driving unit 105 generates the driving current I_{OLED} flowing through the OLED 101 in response to a cross-voltage of the storage capacitor Cst in the light enable phase, and the driving current I_{OLED} is not influenced by the power supply voltage Vdd and the threshold voltage Vₜₕ(T1) of the driving transistor T1. In other words, the driving current I_{OLED} flowing through the OLED 101 is ideally or substantially non-related to the power supply voltage Vdd and the threshold voltage Vₜₕ(T1) of the driving transistor T1.

Besides, the light-emitting control unit 107 includes a light-emitting control transistor T2. Moreover, the data storage unit 109 further includes a writing transistor T3, a collection transistor T4 and a voltage-control transistor T5.

In the present exemplary embodiment, the driving transistor T1, the light-emitting control transistor T2, the writing transistor T3, the collection transistor T4 and the voltage-control transistor T5 can all be implemented by P-type transistors, for example, P-type thin-film-transistors (P-type TFTs), though the invention is not limited thereto. Moreover, an OLED display panel applying the (OLED) pixel circuit 10 of FIG. 2 can be fabricated by using a low-temperature polysilicon (LTPS), amorphous silicon (a-Si) or amorphous indium gallium zinc oxide (a-IGZO) TFT process technique, though the invention is not limited thereto.

Moreover, in a circuit configuration (5T1C) of the (OLED) pixel circuit 10 of FIG. 2, a gate of the driving transistor T1 is coupled to a first terminal (i.e. a node A) of the storage capacitor Cst, and a source of the transistor T1 is coupled to the power supply voltage Vdd.

A gate of the light-emitting control transistor T2 is configured to receive the light enable signal LE, and a source of the light-emitting control transistor T2 is coupled to a drain of the driving transistor T1. An anode (i.e. a first terminal) of the OLED (the light-emitting component) 101 is coupled to a drain of the light-emitting control transistor T2, and a cathode (i.e. a second terminal) of the OLED (the light-emitting component) 101 is coupled to a reference voltage (for example, a ground voltage, though the invention is not limited thereto).

A gate of the writing transistor T3 is configured to receive the writing scan signal S[n], a source of the writing transistor T3 is configured to receive the data voltage Vdata, and a drain of the writing transistor T3 is coupled to a second terminal (i.e. a node B) of the storage capacitor Cst. A gate of the collection transistor T4 is configured to receive the writing scan signal S[n], a source of the collection transistor T4 is coupled to the gate of the driving transistor T1 and the first terminal (i.e. the node A) of the storage capacitor Cst, and a drain of the collection transistor T4 is coupled to the drain of the driving transistor T1. A gate and a source of the voltage-control transistor T5 are coupled to each other to receive the light enable signal LE, and a drain of the voltage-control transistor T5 is coupled to the second terminal (i.e. the node B) of the storage capacitor Cst and the drain of the writing transistor T3.

In addition, during an operation process of the (OLED) pixel circuit 10 of FIG. 2, the light-emitting component driving circuit 103 (i.e. the OLED driving circuit) enters the data-writing phase and the light enable phase in succession, which are, for example, P1 and P2 shown in FIG. 3. In the present exemplary embodiment, in the data-writing phase P1, only the writing scan signal S[n] is enabled. Moreover, in the light enable phase P2, only the light enable signal LE is enabled.

In other words, in the data-writing phase P1, the writing scan signal S[n] is enabled, and the light enable signal LE is disabled. Moreover, in the light enable phase P2, the light enable signal LE is enabled, and the writing scan signal S[n] is disabled. Certainly, a high level (VH) and a low level (VL) of the writing scan signal S[n] and the light enable signal LE can be determined according to an actual design/application requirement.

It should be noticed that since the driving transistor T1, the light-emitting control transistor T2, the writing transistor T3, the collection transistor T4 and the voltage-control transistor T5 in the (OLED) pixel circuit 10 of FIG. 2 are all P-type transistors, it is known that the driving transistor T1, the light-emitting control transistor T2, the writing transistor T3, the collection transistor T4 and the voltage-control transistor T5 are all low active. Therefore, enabling of the writing scan signal S[n] and the light enable signal LE represents that the writing scan signal S[n] and the light enable signal LE are in a low level.

Therefore, in the data-writing phase P1, since only the writing scan signal S[n] is enabled, the driving transistor T1, the writing transistor T3 and the collection transistor T4 are simultaneously in an on state, and the light-emitting control transistor T2 and the voltage-control transistor T5 are simultaneously in an off state in response to disabling of the light enable signal LE, so as to avoid a wrong operation of sudden light up of the OLED 101, and maintain a contrast of a displayed image. In this case, the driving transistor T1 and the collection transistor T4 can be regarded as/equivalent to a diode, and now a voltage on the first terminal (i.e. the node A) of the storage capacitor Cst is Vdd-Vₜₕ(T1), and a voltage on the second terminal (i.e. the node B) of the storage capacitor Cst is the data voltage Vdata, where Vₜₕ(T1) is a threshold voltage of the driving transistor T1. In other words, a voltage difference between the two terminals of the storage capacitor Cst is Vdd-Vₜₕ(T1)−Vdata.

Then, in the light enable phase P2, since only the light enable signal LE is enabled, the driving transistor T1, the light-emitting control transistor T2 and the voltage-control transistor T5 are all in the on state, and the writing transistor T3 and the collection transistor T4 are all in the off state. In this way, the driving transistor T1 generates the driving current I_{OLED} that is not influenced by the power supply voltage Vdd and the threshold voltage Vₜₕ(T1) of the driving transistor T1 to flow through the OLED 101 in response to the cross-voltage of the storage capacitor Cst.

In detail, under the circuit configuration of FIG. 2, the driving current I_{OLED} generated by the driving transistor T1 in the light enable phase P2 can be represented by a following equation (1):

$${I}_{OLED} = \frac{1}{2} K \times {( Vsg - {V}_{th} ( T 1 ) )}^{2} \qquad ( 1 )$$

Where, K is a current constant of the driving transistor T1.

Moreover, since a source gate voltage (Vsg) of the driving transistor T1 is already known, i.e.:

A source voltage (Vs) of the driving transistor T1 is equal to Vdd (i.e., Vs=Vdd);

A gate voltage (Vg) of the driving transistor T1 is equal to a voltage of the node A (i.e., Vg=Vdd-Vₜₕ(T1)−Vdata) (note: the voltage of the node A is equal to Vdd-Vₜₕ(T1)−Vdata in response to conduction of the voltage-control transistor T4 and a capacitor coupling effect of the storage capacitor Cst. In other words, the voltage-control transistor T5 is capable of controlling the terminal voltages of the storage capacitor Cst in the light enable phase P2.); and

Vsg=Vs−Vg=Vdd−(Vdd-Vₜₕ(T1)−Vdata)

Therefore, when the (OLED) pixel circuit 10 shown in FIG. 2 is in the light enable phase P2, if the known source gate voltage (Vsg) of the driving transistor T1 is brought into the equation (1), a following equation (2) is obtained:

$${I}_{OLED} = \frac{1}{2} K \times {[ Vdd - ( Vdd - {V}_{th} ( T 1 ) - Vdata ) - {V}_{th} ( T 1 ) ]}^{2} \qquad ( 2 )$$

The equation (2) can be further simplified into a following equation (3):

$${I}_{OLED} = \frac{1}{2} K \times {( Vdata )}^{2} \qquad ( 3 )$$

Therefore, according to the equation (3), it is clear that under the circuit configuration of FIG. 2, the driving current I_{OLED} flowing through the OLED 101 is ideally or substantially non-related to the power supply voltage Vdd and the threshold voltage Vₜₕ(T1) of the driving transistor T1, and is approximately related to the data voltage Vdata, merely. In this way, a variation of the threshold voltage of the TFT caused by a stress effect can be compensated, and a variation of the power supply voltage Vdd due to influence of the IR drop is also compensated. Besides, according to the circuit configuration of FIG. 2, it is clear that only control signals of the writing scan signal S[n] and the light enable signal LE are required in operation of the (OLED) pixel circuit 10, so that a layout area of the (OLED) pixel circuit 10 is simplified, and the (OLED) pixel circuit 10 is more suitable for application requirements of high resolution panels.

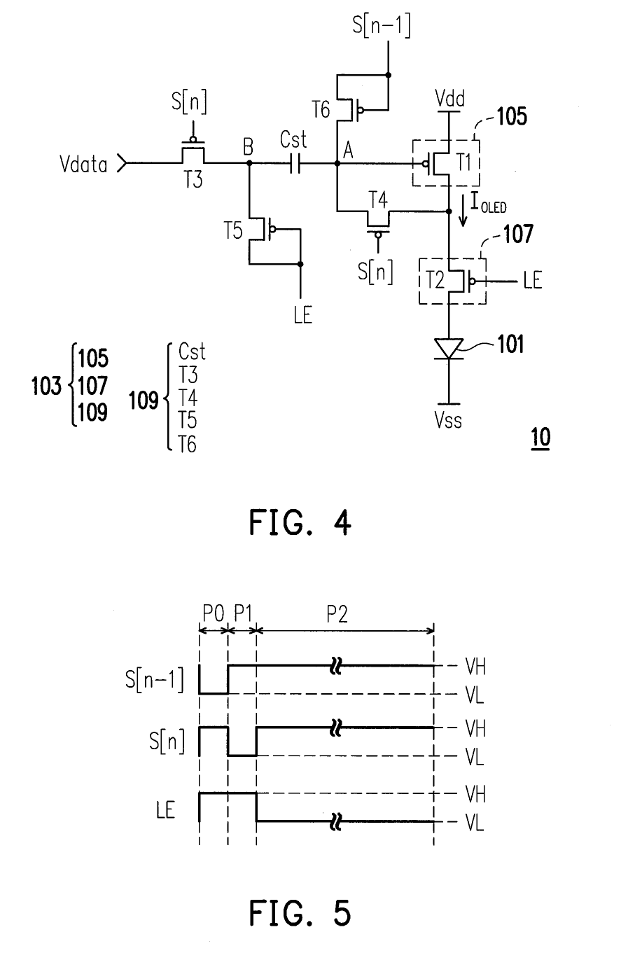

On the other hand, FIG. 4 is another circuit diagram of the (OLED) pixel circuit 10 of FIG. 1. Referring to FIG. 2 and FIG. 4, a difference between the circuit configurations of FIG. 2 and FIG. 4 is only that the circuit configuration of FIG. 4 further includes a reset transistor T6, which can also be implemented by a P-type transistor, for example, a P-type TFT, though the invention is not limited thereto. In this case, the data storage unit 109 of FIG. 4 initializes/resets the first terminal voltage (i.e. the voltage of the node A) of the storage capacitor Cst in response to a reset scan signal S[n-1] in a reset phase (note: the reset scan signal S[n-1] can be a signal on a previous scan line, which is provided by a gate driving circuit of an (n-1)^{th} stage, though the invention is not limited thereto). In the present exemplary embodiment, a gate and a source of the reset transistor T6 are coupled to each other to receive the reset scan signal S[n-1], and a drain of the reset transistor T6 is coupled to the first terminal (i.e. the node A) of the storage capacitor Cst.

Similarly, during an operation process of the (OLED) pixel circuit 10 of FIG. 4, the light-emitting component driving circuit 103 (i.e. the OLED driving circuit) enters the reset phase, the data-writing phase and the light enable phase in succession, which are, for example, P0, P1 and P2 shown in FIG. 5. In the present exemplary embodiment, in the reset phase P0, only the reset scan signal S[n-1] is enabled. In the data-writing phase P1, only the writing scan signal S[n] is enabled. Moreover, in the light enable phase P2, only the light enable signal LE is enabled.

In other words, in the reset phase P0, the reset scan signal S[n-1] is enabled, and the writing scan signal S[n] and the light enable signal LE are disabled. In the data-writing phase P1, the writing scan signal S[n] is enabled, and the reset scan signal S[n-1] and the light enable signal LE are disabled. Moreover, in the light enable phase P2, the light enable signal LE is enabled, and the reset scan signal S[n-1] and the writing scan signal S[n] are disabled. Certainly, a high level (VH) and a low level (VL) of the reset scan signal S[n-1], the writing scan signal S[n] and the light enable signal LE can be determined according to an actual design/application requirement.

It should be noticed that since the driving transistor T1, the light-emitting control transistor T2, the writing transistor T3, the collection transistor T4 and the voltage-control transistor T5 in the (OLED) pixel circuit 10 of FIG. 4 are all P-type transistors, it is known that the driving transistor T1, the light-emitting control transistor T2, the writing transistor T3, the collection transistor T4 and the voltage-control transistor T5 are all low active. Therefore, enabling of the reset scan signal S[n-1], the writing scan signal S[n] and the light enable signal LE represents that the reset scan signal S[n-1], the writing scan signal S[n] and the light enable signal LE are in a low level.

Therefore, in the reset stage P0, since only the reset scan signal S[n-1] is enabled, the voltage (i.e. the gate voltage Vg of the driving transistor T1) of the node A is equal to a low level (VL_{S[n-1]}) of the reset scan signal S[n-1] minus Vₜₕ(T6) as the diode-connected reset transistor T6 is turned on, i.e. VL_{S[n-1]}−Vₜₕ(T6), where Vₜₕ(T6) is a threshold voltage of the reset transistor T6 (such process is to perform initialization/reset on the first terminal voltage (the gate voltage Vg of the driving transistor T1) of the storage capacitor Cst). Meanwhile, in response to disabling of the light enable signal LE, the light-emitting control transistor T2 and the voltage-control transistor T5 are all in the off state, so as to avoid a wrong operation of sudden light up of the OLED 101, and maintain a contrast of a displayed image. Moreover, in response to disabling of the writing scan signal S[n], the writing transistor T3 and the collection transistor T4 are also in the off state.

Then, in the data-writing phase P1, since only the writing scan signal S[n] is enabled, the driving transistor T1, the writing transistor T3 and the collection transistor T4 are simultaneously in the on state, and the light-emitting control transistor T2 and the voltage-control transistor T5 are simultaneously in the off state in response to disabling of the light enable signal LE. In this case, the driving transistor T1 and the collection transistor T4 can be regarded as/equivalent to a diode, and now a voltage on the first terminal (i.e. the node A) of the storage capacitor Cst is Vdd-Vₜₕ(T1), and a voltage on the second terminal (i.e. the node B) of the storage capacitor Cst is the data voltage Vdata. Moreover, in the data-writing phase P1, in response to disabling of the light enable signal LE, the light-emitting control transistor T2 is in the off state, so that the wrong operation of sudden light up of the OLED 101 in the data-writing phase P1 is also avoided.

Finally, in the light enable phase P2, since only the light enable signal LE is enabled, the driving transistor T1, the light-emitting control transistor T2 and the voltage-control transistor T5 are all in the on state, and the writing transistor T3 and the collection transistor T4 are all in the off state. In this way, the driving transistor T1 generates the driving current I_{OLED} that is not influenced by the power supply voltage Vdd and the threshold voltage Vₜₕ(T1) of the driving transistor T1 to flow through the OLED 101 in response to the cross-voltage of the storage capacitor Cst (similar to related descriptions of the aforementioned equations (1)-(3), which are not repeated). In other words, in FIG. 4, the driving transistor T1 also generates the driving current I_{OLED} (shown as the aforementioned equations (1)-(3)) that is not influenced by the power supply voltage Vdd and the threshold voltage Vₜₕ(T1) of the driving transistor T1 to flow through the OLED 101 in the light enable phase P2. Obviously, besides technical effects similar to that of the exemplary embodiment of FIG. 2 is achieved, the circuit configuration of FIG. 4 further has a function/effect of initializing/resetting the first terminal voltage of the storage capacitor Cst (the gate voltage Vg of the driving transistor T1).

Therefore, the circuit configuration of the (OLED) pixel circuit 10 disclosed in the aforementioned exemplary embodiments is 5T1C (i.e. 5 TFTs+one capacitor)/6T1C (i.e. 6 TFTs+one capacitor), and if the circuit configuration collaborates with suitable operation waveforms (shown in FIG. 3 and FIG. 5), the driving current I_{OLED} flowing through the OLED 101 is not changed along with variation of the power supply voltage Vdd influenced by the IR drop, and is not changed along with a threshold voltage (Vth) shift of the driving transistor T1 used for driving the OLED 101. In this way, brightness performance of the applied OLED display is greatly improved.

Besides, any OLED display panel and OLED display applying the (OLED) pixel circuit 10 of the aforementioned embodiments should be considered to be within the scope of the invention.

Moreover, although the OLED pixel circuits of the aforementioned exemplary embodiments all apply the P-type transistors for implementation, the invention is not limited thereto. In other words, those with ordinary skill in the art can deduce a situation that the OLED pixel circuit applies N-type transistors for implementation according to the teachings of the aforementioned embodiments, and such variation or modification embodiments should also be considered to be within the scope of the invention without departing from the spirit and conception of the present invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A light-emitting component driving circuit, comprising:
a driving unit, coupled between a power supply voltage and a light-emitting component, and comprising a driving transistor configured to control a driving current flowing through the light-emitting component in a light enable phase;
a light-emitting control unit, coupled between the driving unit and the light-emitting component, and configured to conduct the driving current come from the driving unit to the light-emitting component in response to a light enable signal in the light enable phase; and
a data storage unit, coupled to the driving unit, comprising a storage capacitor, and configured to store a data voltage and a threshold voltage related to the driving transistor through the storage capacitor in response to a writing scan signal in a data-writing phase, and control terminal voltages of the storage capacitor in response to the light enable signal in the light enable phase,
wherein in the light enable phase, the driving unit generates the driving current flowing through the light-emitting component in response to a cross-voltage of the storage capacitor, and the driving current is not influenced by the threshold voltage of the driving transistor and the power supply voltage.

2. The light-emitting component driving circuit as claimed in claim 1, wherein a gate of the driving transistor is coupled to a first terminal of the storage capacitor, and a source of the driving transistor is coupled to the power supply voltage, and the light-emitting control unit comprises:
a light-emitting control transistor, having a gate receiving the light enable signal, and a source coupled to a drain of the driving transistor,
wherein a first terminal of the light-emitting component is coupled to a drain of the light-emitting control transistor, and a second terminal of the light-emitting component is coupled to a reference voltage,
wherein the light-emitting component is an organic light-emitting diode, and the first terminal of the light-emitting component is an anode of the organic light-emitting diode, and the second terminal of the light-emitting component is a cathode of the organic light-emitting diode.

3. The light-emitting component driving circuit as claimed in claim 2, wherein the data storage unit further comprises:
a writing transistor, having a gate receiving the writing scan signal, a source receiving the data voltage, and a drain coupled to a second terminal of the storage capacitor;
a collection transistor, having a gate receiving the writing scan signal, a source coupled to the gate of the driving transistor and the first terminal of the storage capacitor, and a drain coupled to the drain of the driving transistor; and
a voltage-control transistor, having a gate and a source coupled to each other to receive the light enable signal, and a drain coupled to the second terminal of the storage capacitor and the drain of the writing transistor.

4. The light-emitting component driving circuit as claimed in claim 3, wherein the driving transistor, the light-emitting control transistor, the writing transistor, the collection transistor and the voltage-control transistor are all P-type transistors.

5. The light-emitting component driving circuit as claimed in claim 4, wherein the light-emitting component driving circuit is an organic light-emitting diode driving circuit, and the organic light-emitting diode driving circuit enters the data-writing phase and the light enable phase in succession,
wherein in the data-writing phase, the writing scan signal is enabled, and the light enable signal is disabled,
wherein in the light enable phase, the light enable signal is enabled, and the writing scan signal is disabled.

6. The light-emitting component driving circuit as claimed in claim 4, wherein the data storage unit initializes a first terminal voltage of the storage capacitor in response to a reset scan signal in a reset phase,
wherein the data storage unit further comprises a reset transistor, wherein a gate and a source of the reset transistor are coupled to each other to receive the reset scan signal, and a drain of the reset transistor is coupled to the first terminal of the storage capacitor,
wherein the reset transistor is a P-type transistor.

7. The light-emitting component driving circuit as claimed in claim 6, wherein the light-emitting component driving circuit is an organic light-emitting diode driving circuit, and the organic light-emitting diode driving circuit enters the reset phase, the data-writing phase and the light enable phase in succession,
wherein in the reset phase, the reset scan signal is enabled, and the writing scan signal and the light enable signal are disabled,
wherein in the data-writing phase, the writing scan signal is enabled, and the reset scan signal and the light enable signal are disabled,
wherein in the light enable phase, the light enable signal is enabled, and the reset scan signal and the writing scan signal are disabled.

8. A pixel circuit, comprising:
a light-emitting component, configured to emit light in response to a driving current in a light enable phase;
a driving unit, coupled between a power supply voltage and the light-emitting component, and comprising a driving transistor configured to control the driving current flowing through the light-emitting component in the light enable phase;
a light-emitting control unit, coupled between the driving unit and the light-emitting component, and configured to conduct the driving current come from the driving unit to the light-emitting component in response to a light enable signal in the light enable phase; and
a data storage unit, coupled to the driving unit, comprising a storage capacitor, and configured to store a data voltage and a threshold voltage related to the driving transistor through the storage capacitor in response to a writing scan signal in a data-writing phase, and control terminal voltages of the storage capacitor in response to the light enable signal in the light enable phase,
wherein in the light enable phase, the driving unit generates the driving current flowing through the light-emitting component in response to a cross-voltage of the storage capacitor, and the driving current is not influenced by the threshold voltage of the driving transistor and the power supply voltage.

9. The pixel circuit as claimed in claim 8, wherein a gate of the driving transistor is coupled to a first terminal of the storage capacitor, and a source of the driving transistor is coupled to the power supply voltage, and the light-emitting control unit comprises:
a light-emitting control transistor, having a gate receiving the light enable signal, and a source coupled to a drain of the driving transistor,
wherein a first terminal of the light-emitting component is coupled to a drain of the light-emitting control transistor, and a second terminal of the light-emitting component is coupled to a reference voltage,
wherein the light-emitting component is an organic light-emitting diode, and the first terminal of the light-emitting component is an anode of the organic light-emitting diode, and the second terminal of the light-emitting component is a cathode of the organic light-emitting diode,
wherein, the pixel circuit is an organic light-emitting diode pixel circuit,
wherein the driving unit, the data storage unit and the light-emitting control unit construct an organic light-emitting diode driving circuit.

10. The pixel circuit as claimed in claim 9, wherein the data storage unit further comprises:
a writing transistor, having a gate receiving the writing scan signal, a source receiving the data voltage, and a drain coupled to a second terminal of the storage capacitor;
a collection transistor, having a gate receiving the writing scan signal, a source coupled to the gate of the driving transistor and the first terminal of the storage capacitor, and a drain coupled to the drain of the driving transistor; and
a voltage-control transistor, having a gate and a source coupled to each other to receive the light enable signal, and a drain coupled to the second terminal of the storage capacitor and the drain of the writing transistor.

11. The pixel circuit as claimed in claim 10, wherein the driving transistor, the light-emitting control transistor, the writing transistor, the collection transistor and the voltage-control transistor are all P-type transistors.

12. The pixel circuit as claimed in claim 11, wherein the organic light-emitting diode driving circuit enters the data-writing phase and the light enable phase in succession,
wherein in the data-writing phase, the writing scan signal is enabled, and the light enable signal is disabled,
wherein in the light enable phase, the light enable signal is enabled, and the writing scan signal is disabled.

13. The pixel circuit as claimed in claim 11, wherein the data storage unit initializes a first terminal voltage of the storage capacitor in response to a reset scan signal in a reset phase,
wherein the data storage unit further comprises a reset transistor, wherein a gate and a source of the reset transistor are coupled to each other to receive the reset scan signal, and a drain of the reset transistor is coupled to the first terminal of the storage capacitor,
wherein the reset transistor is a P-type transistor.

14. The pixel circuit as claimed in claim 13, wherein the organic light-emitting diode driving circuit enters the reset phase, the data-writing phase and the light enable phase in succession,
wherein in the reset phase, the reset scan signal is enabled, and the writing scan signal and the light enable signal are disabled,
wherein in the data-writing phase, the writing scan signal is enabled, and the reset scan signal and the light enable signal are disabled,
wherein in the light enable phase, the light enable signal is enabled, and the reset scan signal and the writing scan signal are disabled.

15. An organic light-emitting diode display panel having the pixel circuit as claimed in claim 8.

16. An organic light-emitting diode display having the organic light-emitting diode display panel as claimed in claim 15.
